(19) United States
(12) Patent Application Publication
(10) Pub. No.: US 2015/0170574 A1
(43) Pub. Date: Jun. 18, 2015

(54) DISPLAY DEVICE AND METHOD FOR DRIVING THE SAME

(71) Applicant: SAMSUNG DISPLAY CO., LTD., Yongin-City (KR)

(72) Inventor: Ki-Wook Kim, Hwaseong-si (KR)

(73) Assignee: SAMSUNG DISPLAY CO., LTD., Yongin-City (KR)

(21) Appl. No.: 14/276,756

(22) Filed: May 13, 2014

(30) Foreign Application Priority Data
Dec. 13, 2013 (KR) 10-2013-0155731

(51) Int. Cl. G09G 3/32

(52) U.S. Cl. CPC G09G 3/3275; G09G 2330/00

(57) ABSTRACT

A display device includes: a display panel including a plurality of pixels arranged in a matrix form; a first power source line and a second power source line configured to apply a driving power to the plurality of pixels; and a power supply configured to supply a driving power to the first power source line and the second power source line, wherein the first power source line and the second power source line are coupled to each other at one side of the display panel, and are coupled to the power supply at another side that is opposite to the one side of the display panel.

### CROSS-REFERENCE TO RELATED APPLICATION

This application claims priority to and the benefit of Korean Patent Application No. 10-2013-0155731, filed on Dec. 13, 2013, with the Korean Intellectual Property Office, the disclosure of which is incorporated herein in its entirety by reference.

### BACKGROUND

1. Field

Embodiments of the present invention relate to a display device and to a driving method thereof.

2. Description of the Related Art

Display devices include a plurality of pixels provided in an area defined by a black matrix or a pixel defining layer. The display devices include, for example, liquid crystal displays (LCDs), organic light emitting diode displays (OLED displays), electrophoretic displays, and the like.

Among the display devices, the OLED display is a self-emission display device that emits light from phosphors by recombination of electrons and holes, and is classified into two respective categories, i.e., a passive-matrix OLED display and an active-matrix OLED display, according to respective drive methods.

In the active-matrix OLED display, a plurality of pixels are arranged in a matrix, emission of the pixels is controlled using switching elements such as thin film transistors (TFTs) in the pixels, and display is achieved or performed through scan lines that select the pixels, data lines that control the emission of the pixels, and power supply units that supply a driving voltage ELVDD to the pixels.

The power supply units supply a uniform driving voltage ELVDD to each pixel via a plurality of power source lines. The driving voltage ELVDD applied through the plurality of power source lines should have the same value for each pixel. However, this can be difficult to achieve due to IR drop (e.g., voltage drop) occurring in the power source lines.

In other words, as the distance from the power supply unit to the pixel increases, the driving voltage ELVDD supplied to each pixel is reduced due to the IR drop such that the display device may have non-uniform brightness.

### SUMMARY

Aspects of embodiments of the present invention are directed to a display device capable of decreasing (e.g., preventing) brightness non-uniformity caused by IR drop occurring in a power source line, and to a method of driving the display device.

According to an embodiment of the present invention, a display device includes: a display panel including a plurality of pixels arranged in a matrix form; a first power source line and a second power source line configured to apply a driving power to the plurality of pixels; and a power supply configured to supply a driving power to the first power source line and the second power source line, wherein the first power source line and the second power source line are coupled to each other at one side of the display panel, and are coupled to the power supply at another side that is opposite to the one side of the display panel.

The first power source line and the second power source line may extend parallel to each other in a row or a column direction.

The display device may further include: a first transistor configured to couple the first power source line and the power supply; a second transistor configured to couple the second power source line and the power supply; and a control signal applier configured to apply control signals to the first and second transistors for alternately coupling the first and second power source lines, respectively, and the power supply.

The control signal applier may be configured to generate a first control signal for turning on or off the first transistor, and a second control signal for turning on or off the second transistor, the second control signal having a different phase from the first control signal.

The first power source line may be coupled to the power supply by the first control signal during one frame, and the second power source line may be coupled to the power supply by the second control signal during another frame.

The first power source line may be coupled to the power supply by the first control signal during a partial period of one frame, and the second power source line may be coupled to the power supply by the second control signal during a remaining period of the one frame.

The display device may further include a switch configured to selectively couple the first power source line and the second power source line to the power supply.

According to another embodiment of the present invention, a method of driving a display device including a first power source line and a second power source line to apply a driving power to each of a plurality of pixels, and a power supply configured to supply the driving power to the first and second power source lines includes: alternately coupling the first power source line and the second power source line to the power supply.

The first power source line may be coupled to the power supply during one frame and the second power source line may be coupled to the power supply during another frame.

The first power source line may be coupled to the power supply during a partial period of one frame and the second power source line may be coupled to the power supply during a remaining period of the one frame.

According to embodiments of the present invention, in the display device and the driving method thereof, the average amount of IR drop is substantially the same regardless of the position of the display panel, and therefore an image having uniform brightness may be displayed throughout the whole display panel.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of embodiments of the present invention will be more clearly understood from the following detailed description taken in conjunction with the accompanying drawings, in which:

FIG. 1 is a schematic plan view showing a conventional organic light emitting diode display;

FIG. 2 is a view showing a voltage distribution of the conventional organic light emitting diode display shown in FIG. 1;

FIG. 3 is a schematic plan view showing an organic light emitting diode display according to a first embodiment of the present invention;

FIGS. 4 and 5 are timing diagrams illustrating a method of driving the organic light emitting diode display according to the first embodiment of the present invention;

FIGS. 6 and 7 are plan views illustrating the method of driving the organic light emitting diode display according to the first embodiment of the present invention;

FIG. 8 is a schematic plan view showing an organic light emitting diode display according to a second embodiment of the present invention;

FIG. 9 is a block diagram showing a switching unit of the organic light emitting diode display according to the second embodiment of the present invention; and

FIGS. 10, 11, and 12 are timing diagrams illustrating a method of driving the organic light emitting diode display according to the second embodiment of the present invention.

### DETAILED DESCRIPTION

Hereinafter, embodiments of the present invention will be described in more detail with reference to the accompanying drawings.

Although the present invention may be modified in various manners and has several embodiments, specific embodiments are illustrated in the accompanying drawings and will be mainly described in the specification. However, the scope of the present invention is not limited to the specific embodiments and should be construed as including all the changes, equivalents, and substitutions included in the spirit and scope of the present invention.

It will be understood that when an element such as a layer, film, region, or substrate is referred to as being “on”, “connected to” or “coupled to” another element or layer, it may be directly on, connected to or coupled to the other element or layer, or intervening elements or layers may be present. It will be further understood that the terms “comprises,” “comprising,” “includes” and/or “including,” when used in this specification, specify the presence of stated features, integers, steps, operations, elements, components, and/or groups, but do not preclude the presence or addition of one or more other features, integers, steps, operations, elements, components, and/or groups thereof.

It will be understood that, although the terms “first,” “second,” and “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed “a second element,” “component,” “region,” “layer” or “section” without departing from the teachings herein.

Some of the parts which are not associated with the description may not be provided in order to specifically describe embodiments of the present invention, and like reference numerals refer to like elements throughout the specification.

In embodiments of the present invention, the number of frames refers to the number of images displayed in a display panel per second, and image data used for each frame is delayed through a shift register so as to be input into a timing controller or a data driver. Therefore, the image data input into the timing controller and into the data driver may be different from each other according to the frames. According to embodiments of the present invention, the frame is defined based on image data input to all pixels of the display panel during a period of time (e.g., a predetermined period of time).

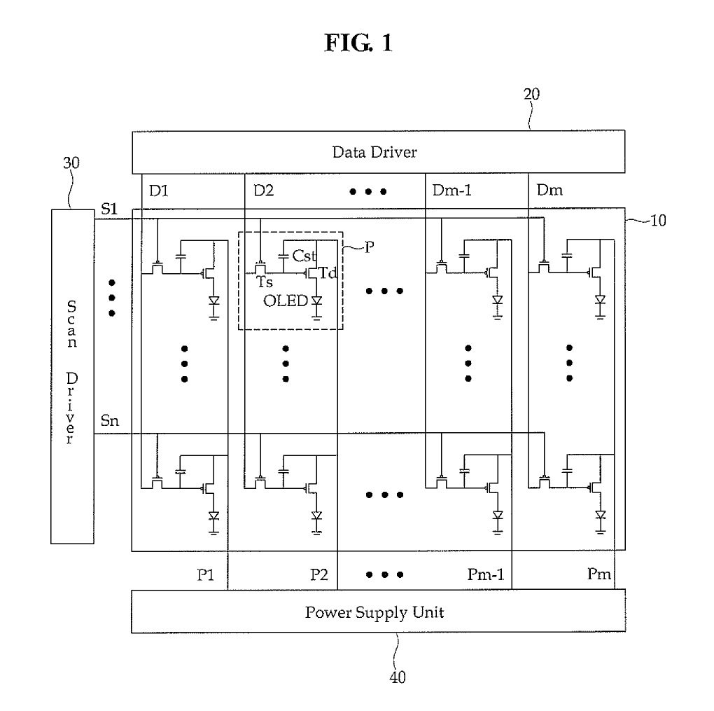

FIG. 1 is a schematic plan view showing a conventional organic light emitting diode display.

Referring to FIG. 1, the conventional organic light emitting diode display includes a display panel 10 including a plurality of pixels P arranged in a matrix, a data driver 20 configured to transmit data signals to the pixels P through a plurality of data lines D1 to Dm, a scan driver 30 configured to transmit scan signals to the pixels P through a plurality of scan lines S1 to Sn, and a power supply unit (e.g., a power supply or a power supplier) 40 configured to supply a driving voltage ELVDD to the pixels P through a plurality of power source lines P1 to Pm.

The pixel P emits light from an organic light emitting diode (OLED) by an electric current corresponding to the scan signals applied through the scan lines S1 to Sn and the data signals applied through the data lines D1 to Dm so as to display an image.

The power supply unit 40 applies a positive driving voltage ELVDD having a predetermined level to each pixel P through the plurality of power source lines P1 to Pm. However, due to IR drop occurring in the power source lines P1 to Pm, the driving voltage ELVDD applied to the pixel P relatively far from the power supply unit 40 has a different level from the driving voltage ELVDD applied to the pixel P relatively close to the power supply unit 40.

In other words, as the distance between the power supply unit 40 and the pixel P becomes shorter, the IR drop of the power source lines P1 to Pm becomes lower, whereas as the distance between the power supply unit 40 and the pixel P becomes longer, the IR drop of the power source lines P1 to Pm becomes higher.

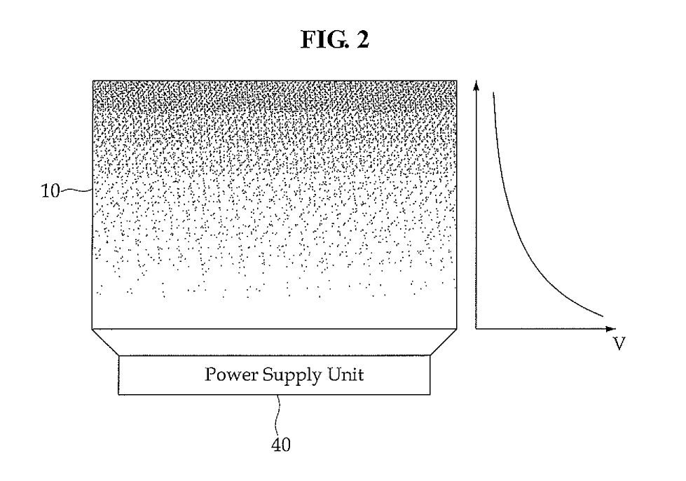

FIG. 2 is a view showing a voltage distribution of the conventional organic light emitting diode display shown in FIG. 1. FIG. 2 shows a simulation result of the voltage distribution in the case where the power supply unit 40 configured to supply a driving voltage ELVDD is under the display panel.

As shown in FIG. 2, in the case where the power supply unit 40 configured to supply a driving voltage ELVDD is under the display panel, an IR drop of the driving voltage ELVDD may increase or become higher from a bottom or lower part of the display panel to a top or an upper part thereof. For example, the driving voltage

ELVDD may be less at the pixels at the top of the display panel 10 than at the pixels at the bottom of the display panel 10 due to IR drop. Consequentially, an image displayed in the upper and lower parts of the display panel 10 may have non-uniform emission brightness such that the pixels fail to display an image having a desired brightness. For example, the pixels at the lower parts of the display panel 10 may be brighter than the pixels at the upper parts of the display panel 10. Such a problem becomes more serious as the display panel becomes larger in size. The graph shown in FIG. 2 illustrates the voltage at the display panel 10 in relation to distance from the power supply unit.

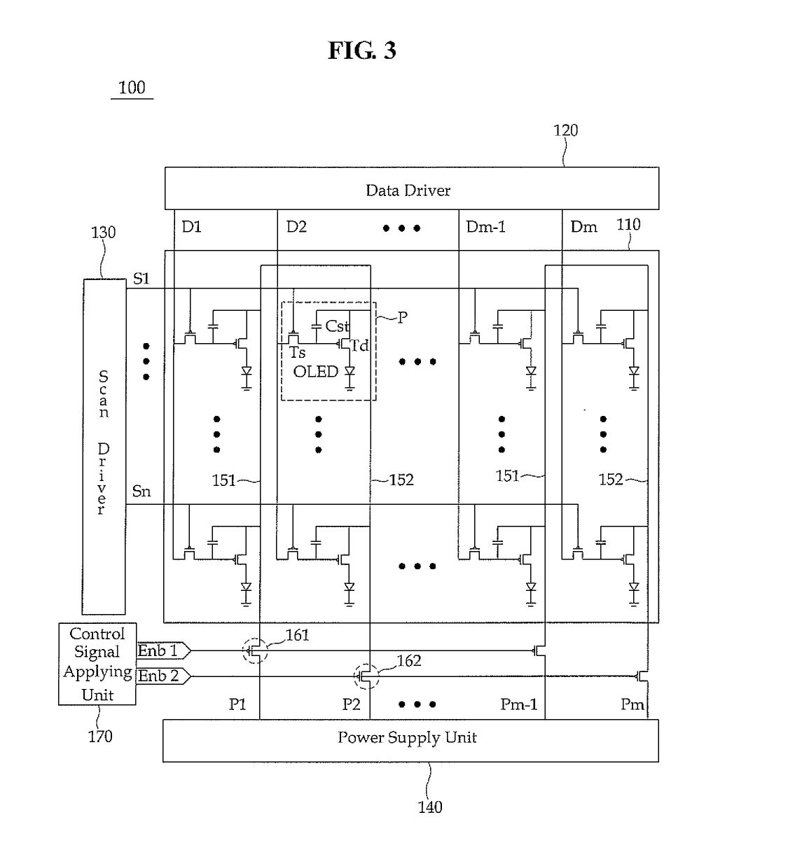

FIG. 3 is a schematic plan view showing an organic light emitting diode display (OLED display) according to a first embodiment of the present invention.

Referring to FIG. 3, the OLED display 100 according to the first embodiment of the present invention includes a display panel 110 including a plurality of pixels P arranged in a matrix form, a data driver 120 configured to transmit data signals to the pixels P through a plurality of data lines D1 to Dm, a scan driver 130 configured to transmit scan signals to the pixels P through a plurality of scan lines S1 to Sn, and a power supply unit 140 configured to supply a driving voltage ELVDD to the pixels P through a plurality of power source lines P1 to Pm.

Hereinafter, for ease of description, odd power source lines P1, P3, etc. of the plurality of power source lines P1 to Pm are collectively called a first power source line 151, and even power source lines P2, P4, etc. of the plurality of power source lines P1 to Pm are collectively called a second power source line 152.

Referring to FIG. 3, the first and second power source lines 151 and 152 extend in a column direction of the display panel 110, and are configured to apply a driving voltage ELVDD to each of the plurality of pixels P arranged in a column direction. However, the first and second power source lines 151 and 152 are not limited thereto, and may extend in a row direction of the display panel 110, and may be configured to apply a driving voltage ELVDD to each of the plurality of pixels P arranged in a row direction.

The first power source line 151 may be electrically coupled (e.g., connected) to the second power source line 152 adjacent to the first power source line 151 at one side of the display panel 110.

For instance, in the case where the power supply unit 140 is at a lower part of the display panel 110, the first and second power source lines 151 and 152 may be electrically coupled (e.g., connected) to each other at an upper part of the display panel 110. Further, in the case where the power supply unit 140 is at the upper part of the display panel 110, the first and second power source lines 151 and 152 may be electrically coupled to each other at the lower part of the display panel 110.

In the case where the first and second power source lines 151 and 152 extend in a row direction of the display panel 110, they may be electrically coupled to each other at a left or right side of the display panel 110.

Hereinafter, with respect to the display panel 110, an area where the first and second power source lines 151 and 152 are electrically coupled to each other will be called one side of the display panel 110, and an area opposite the one side of the display panel 110 will be called the other side of the display panel 110.

According to an embodiment of the present invention, the first and second power source lines 151 and 152 may be alternately coupled to the power supply unit 140 by a control signal applying unit (or control signal applier) 170 on a frame basis (e.g., on a per frame basis). In other words, the first power source line 151 and the power supply unit 140 may be coupled to each other by the control signal applying unit 170 in one frame period, and the second power source line 152 and the power supply unit 140 may be coupled to each other by the control signal applying unit 170 in the next frame period.

According to another embodiment of the present invention, the first and second power source lines 151 and 152 may be alternately coupled to the power supply unit 140 by the control signal applying unit 170 at least once in or during one frame period. In other words, the first power source line 151 and the power supply unit 140 may be coupled to each other by the control signal applying unit 170 in or during a partial period of one frame, and the second power source line 152 and the power supply unit 140 may be coupled to each other by the control signal applying unit 170 in or during the remaining period of the one frame.

Referring back to FIG. 3, the OLED display 100 according to the first embodiment of the present invention may further include a first transistor 161 configured to couple the first power source line 151 and the power supply unit 140, and a second transistor 162 configured to couple the second power source line 152 and the power supply unit 140.

Also, the OLED display 100 according to the first embodiment of the present invention may further include a control signal applying unit 170 configured to apply a first control signal Enb1 and a second control signal Enb2 having a phase difference from the first control signal Enb1, to the first and second transistors 161 and 162, respectively.

The first transistor 161 may receive the first control signal Enb1 so as to be turned on or off, and the second transistor 162 may receive the second control signal Enb2 having a phase difference from the first control signal Enb1 so as to be turned on or off.

Referring to FIG. 3, the first and second transistors 161 and 162 may be PMOS transistors that are turned on when low level signals are applied, but they are not limited thereto.

In the event that the first transistor 161 is turned on, a driving voltage ELVDD may be applied to the first power source line 151 from the power supply unit 140, and in the event that the second transistor 162 is turned on, a driving voltage ELVDD may be applied to the second power source line 152 from the power supply unit 140.

The pixel P may include a switching transistor Ts that is turned on by scan signals to transmit data signals, a storage capacitor Cst configured to store the data signals, and a driving transistor Td configured to drive an organic light emitting diode (OLED) corresponding to the data signals.

The pixel P is illustrated as having a structure of 2 Tr 1 C (i.e., two transistors and one capacitor) in FIG. 3, but this is not limited thereto. The pixel P may further include an additional transistor configured to compensate for threshold voltage of the driving transistor Td or to initialize the driving transistor Td, and a compensation circuit for driving the additional transistor. The transistors included in the pixel P are PMOS transistors according to an embodiment of the present invention, but the transistors are not limited thereto. One or more of the transistors included in the pixel P may be NMOS transistors in other embodiments.

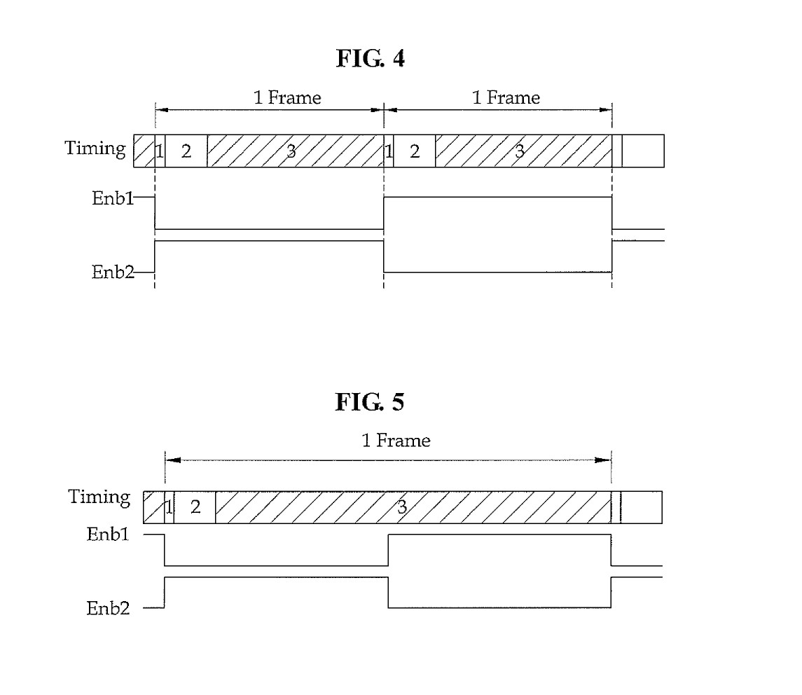

FIGS. 4 and 5 are timing diagrams illustrating a method of driving the OLED display according to the first embodiment of the present invention. The number of frames refers to the number of images displayed in the display panel per second, and for example, one frame period may include an initialization period 1, a threshold voltage compensation period 2, a light emission period 3, and the like.

Hereinafter, the first and second transistors 161 and 162 will be described as PMOS transistors that are turned on when low level signals are applied.

The first transistor 161 may receive the first control signal Enb1 so as to be turned on or off, and the second transistor 162 may receive the second control signal Enb2 having a phase difference from the first control signal Enb1 so as to be turned on or off.

Referring to FIG. 4, the first and second control signals Enb1 and Enb2 may be applied at a level that turns on each of the first and second transistors 161 and 162 in each frame period. In other words, the first control signal Enb1 may be applied at a level for turning on the first transistor 161 in one frame period, and the second control signal Enb2 may be applied at a level for turning on the second transistor 162 in the following frame period.

Referring to FIG. 5, the first and second control signals Enb1 and Enb2 may be applied at a level that turns on the first and second transistors 161 and 162, respectively, during corresponding partial periods of one frame period. In other words, the first control signal Enb1 may be applied at a level for turning on the first transistor 161 during a partial period of one frame period, and the second control signal Enb2 may be applied at a level for turning on the second transistor 162 during the remaining period of the one frame period.

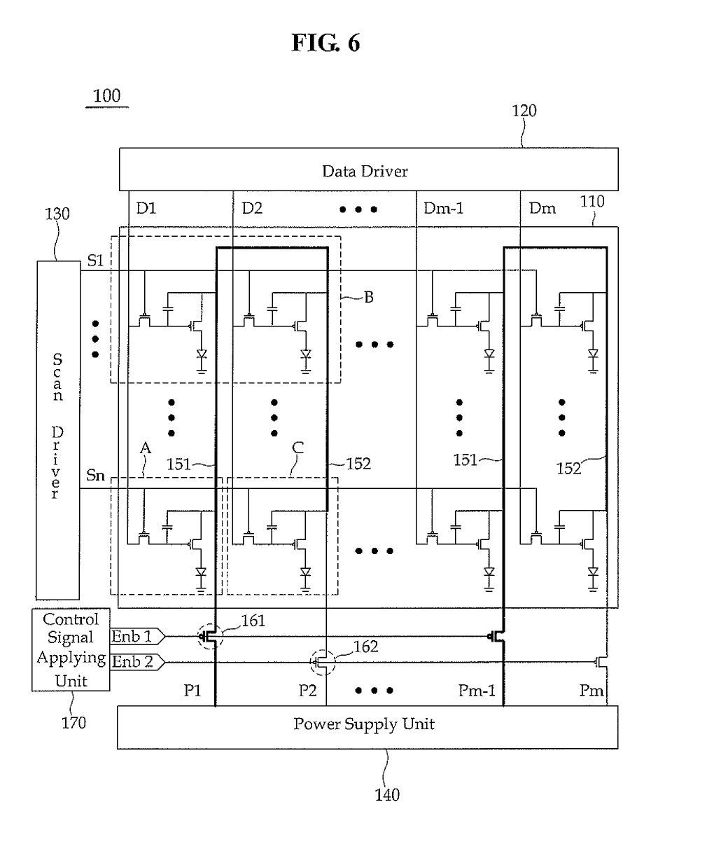

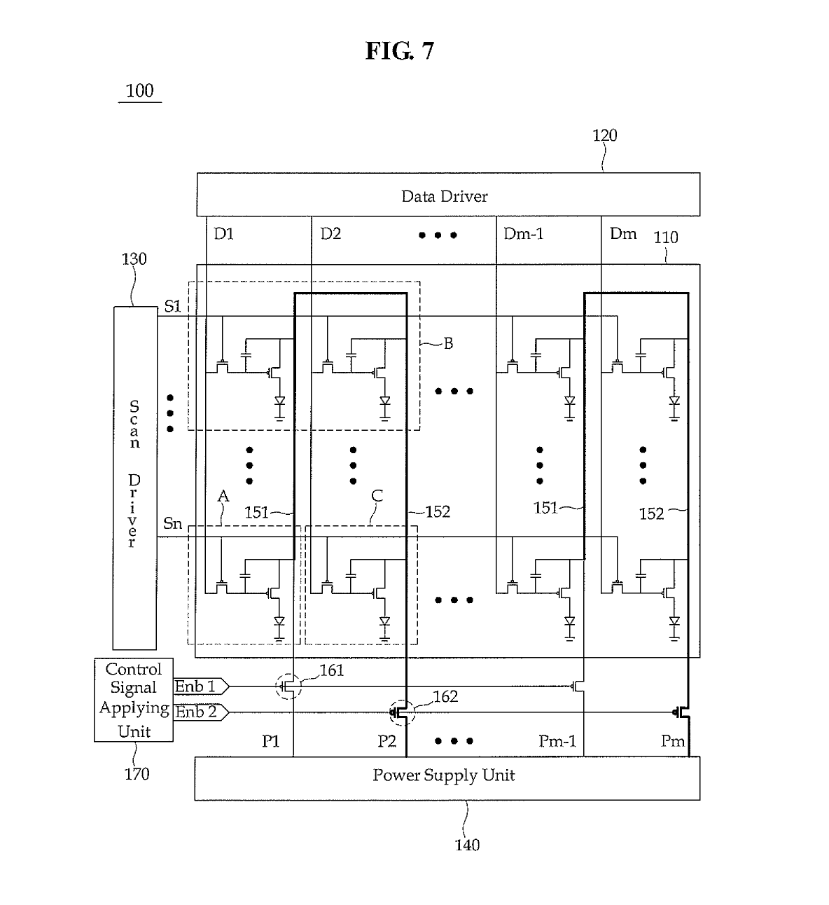

FIGS. 6 and 7 are plan views illustrating the method of driving the OLED display according to the first embodiment of the present invention.

FIG. 6 shows that the first control signal Enb1 has a low level, and the second control signal Enb2 has a high level, so that the first transistor 161 is turned on and the second transistor 162 is turned off.

Referring to FIG. 6, an IR drop occurring in the power source line is low at an area or region A because the power source line coupled to the power supply unit 140 is relatively short in length. The IR drop occurring in the power source line has a value that is between relatively high and relatively low values at an area or region B because the power source line coupled to the power supply unit 140 is between relatively long and relatively short lengths. The IR drop occurring in the power source line is high at an area or region C because the power source line coupled to the power supply unit 140 is relatively long in length.

FIG. 7 shows that the first control signal Enb1 has a high level signal, and the second control signal Enb2 has a low level signal, so that the first transistor 161 is turned off and the second transistor 162 is turned on.

Referring to FIG. 7, the IR drop occurring in the power source line is high at an area A because the power source line coupled to the power supply unit 140 is relatively long in length. The IR drop occurring in the power source line has a value that is between relatively high and relatively low values at an area B because the power source line coupled to the power supply unit 140 is between relatively long and relatively short lengths. The IR drop occurring in the power source line is low at an area C because the power source line coupled to the power supply unit 140 is relatively short in length.

Referring to FIGS. 6 and 7, the IR drop appears to be high and low alternately in the areas A and C, and it appears only to have a value that is between relatively high and relatively low values in the area B. In the case where the pixel P is supplied with a data signal having a frequency at which brightness change is not perceivable by the human eye, the entire display panel may be uniformly seen because the human eye perceives cumulative brightness.

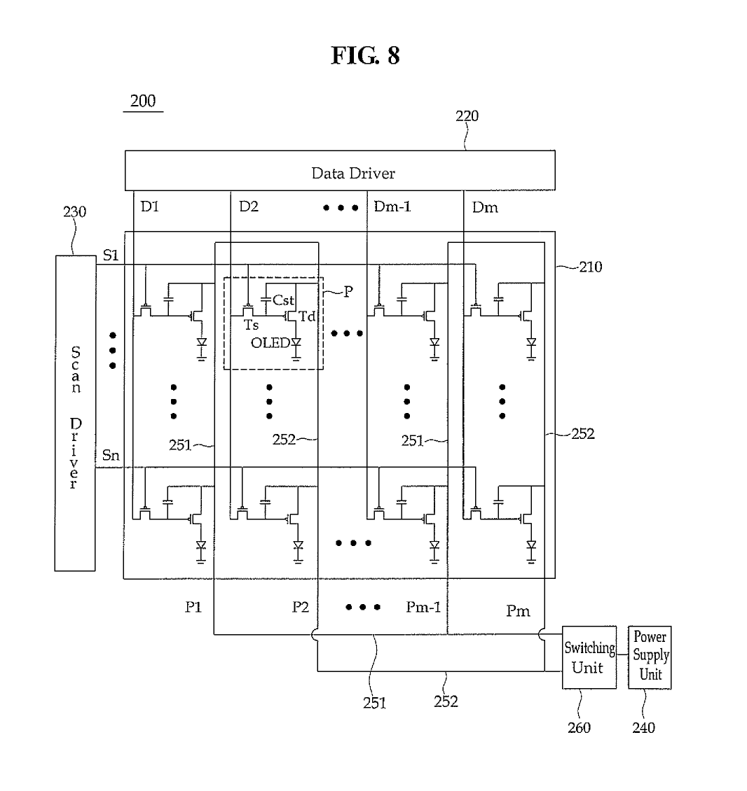

FIG. 8 is a schematic plan view showing an OLED display according to a second embodiment of the present invention.

The OLED display 200 according to the second embodiment of the present invention is partially identical to the OLED display 100 according to the first embodiment of the present invention, and thus the repeated description of the OLED display 200 may be omitted.

Referring to FIG. 8, the OLED display 200 according to the second embodiment of the present invention includes a display panel 210 including a plurality of pixels P arranged in a matrix form, a data driver 220 configured to transmit data signals to the pixels P through a plurality of data lines D1 to Dm, a scan driver 230 configured to transmit scan signals to the pixels P through a plurality of scan lines S1 to Sn, and a power supply unit 240 configured to supply a driving voltage ELVDD to the pixels P through a plurality of power source lines P1 to Pm.

Hereinafter, for ease of description, odd power source lines P1, P3, etc. of the plurality of power source lines P1 to Pm are collectively called a first power source line 251, and even power source lines P2, P4, etc. of the plurality of power source lines P1 to Pm are collectively called a second power source line 252.

The plurality of first power source lines 251 and the plurality of second power source lines 252 may be coupled to the power supply unit 240 through a switching unit 260.

The switching unit 260 may selectively couple the first power source line 251 and the second power source line 252 to the power supply unit 240.

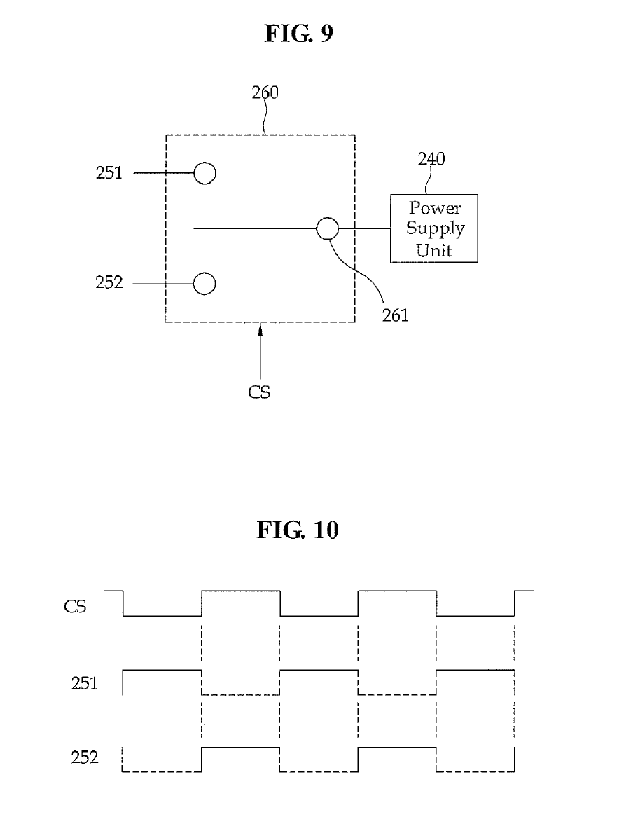

FIG. 9 is a block diagram showing the switching unit of the OLED display according to the second embodiment of the present invention.

Referring to FIG. 9, the switching unit 260 is provided with a switch 261 configured to selectively couple the first power source line 251 and the second power source line 252 to the power supply unit 240. The switch 261 applies a driving voltage ELVDD to the first power source line 251 or the second power source line 252, switched from the first power source line 251, in response to a control signal CS.

FIG. 10 is a diagram illustrating a method of driving the switching unit of the OLED display according to the second embodiment of the present invention.

Referring to FIG. 10, the switch 261 selectively couples the first power source line 251 or the second power source line 252 to the power supply unit 240 in response to a control signal CS. For instance, in the case where the control signal CS has a low level value, the switch 261 may couple the first power source line 251 to the power supply unit 240, and in the case where the control signal CS has a high level value, the switch 261 may couple the second power source line 252 to the power supply unit 240. The control signal CS may be supplied by the outside, e.g., by a timing controller, etc.

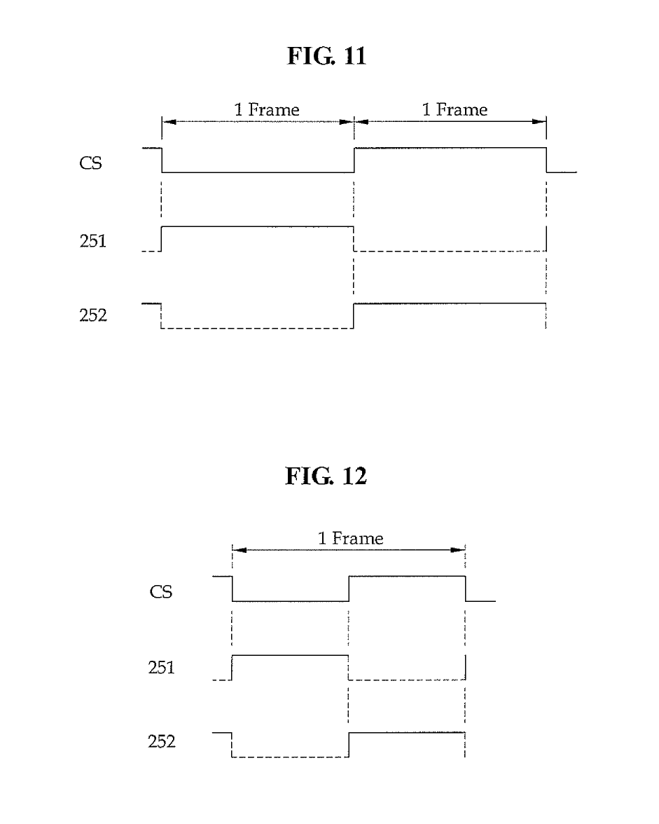

FIGS. 11 and 12 are diagrams illustrating timing of driving the control signal CS of the OLED display according to the second embodiment of the present invention.

Referring to FIG. 11, the control signal CS may be applied during one frame period. That is, a low level value may be applied during one frame period, and a high level value may be applied during the following frame period.

In other words, the first power source line 251 may be coupled to the power supply unit 240 during one frame period, and the second power source line 252 may be coupled to the power supply unit 240 during the next one frame period.

Referring to FIG. 12, the control signal CS may be applied at least once during one frame period. That is, each of a low level value and a high level value may be applied at least once in one frame period.

In other words, the first power source line 251 may be coupled to the power supply unit 240 during a partial period of one frame period, and the second power source line 252 may be coupled to the power supply unit 240 during the remaining period of the one frame period.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims, and equivalents thereof.

What is claimed is:

1. A display device comprising:
a display panel comprising a plurality of pixels arranged in a matrix form;
a first power source line and a second power source line configured to apply a driving power to the plurality of pixels; and
a power supply configured to supply a driving power to the first power source line and the second power source line,
wherein the first power source line and the second power source line are coupled to each other at one side of the display panel, and are coupled to the power supply at another side that is opposite to the one side of the display panel.

2. The display device of claim 1, wherein the first power source line and the second power source line extend parallel to each other in a row or a column direction.

3. The display device of claim 1, further comprising:
a first transistor configured to couple the first power source line and the power supply;
a second transistor configured to couple the second power source line and the power supply; and
a control signal applier configured to apply control signals to the first and second transistors for alternately coupling the first and second power source lines, respectively, and the power supply.

4. The display device of claim 3, wherein the control signal applier is configured to generate a first control signal for turning on or off the first transistor, and a second control signal for turning on or off the second transistor, the second control signal having a different phase from the first control signal.

5. The display device of claim 4, wherein the first power source line is coupled to the power supply by the first control signal during one frame, and the second power source line is coupled to the power supply by the second control signal during another frame.

6. The display device of claim 4, wherein the first power source line is coupled to the power supply by the first control signal during a partial period of one frame, and the second power source line is coupled to the power supply by the second control signal during a remaining period of the one frame.

7. The display device of claim 1, further comprising a switch configured to selectively couple the first power source line and the second power source line to the power supply.

8. A method of driving a display device comprising a first power source line and a second power source line to apply a driving power to each of a plurality of pixels, and a power supply configured to supply the driving power to the first and second power source lines, the method comprising:
alternately coupling the first power source line and the second power source line to the power supply.

9. The method of claim 8, wherein the first power source line is coupled to the power supply during one frame and the second power source line is coupled to the power supply during another frame.

10. The method of claim 8, wherein the first power source line is coupled to the power supply during a partial period of one frame and the second power source line is coupled to the power supply during a remaining period of the one frame.
